(19) United States
(12) Patent Application Publication
(10) Pub. No.: US 2008/0198173 A1
(43) Pub. Date: Aug. 21, 2008

(54) DRIVING OF A CHOLESTERIC LIQUID CRYSTAL DISPLAY APPARATUS

(76) Inventors: David COATES, Wimbourne (GB); Christopher John Hughes, Reading (GB)

Correspondence Address: Pearl Cohen Zedek Latzer, LLP, 1500 Broadway, 12th Floor, New York, NY, 10036, US

(21) Appl. No.: 12/030,891

(22) Filed: Feb. 14, 2008

(30) Foreign Application Priority Data
Feb. 15, 2007 (GB) 0702977.0

(51) Int. Cl. G09G 3/36; G09G 5/00

(52) U.S. Cl. 345/596; 345/89

(57) ABSTRACT

A cholesteric liquid crystal display apparatus is driven in accordance with image data having a predetermined number of possible grey levels. Drive signals are applied to the electrodes of the at least one cell which drive each pixel of the display apparatus into a state selected from a number of predetermined states in accordance with the image data. A number of predetermined states less than the predetermined number of possible grey levels of the image data is used but the image data is error diffusion dithered so that the spatial filtering performed by the eye of the viewer compensates for the low number of states used. By using such a low number of states, there are achieved several advantages in the design of the drive circuit which increase its simplicity and reduce cost.

### BACKGROUND OF THE INVENTION

(1) Field of the Invention

The present invention relates to a cholesteric liquid crystal display apparatus comprising a cholesteric liquid crystal display device and to the driving of the cholesteric liquid crystal display device to display an image in accordance with image data.

(2) Description of Related Art

A cholesteric liquid crystal display device is a type of reflective display device having a low power consumption and a high brightness. A cholesteric liquid crystal display device uses one or more cells each having a layer of cholesteric liquid crystal material capable of being switched between a plurality of states having different reflectances. These states include a planar state being a stable state in which the layer of cholesteric liquid crystal material reflects light with wavelengths in a band corresponding to a predetermined colour. In another state, the cholesteric liquid crystal transmits light which may then be absorbed for example by a rear black layer so that the light is not reflected. A full colour display may be achieved by stacking layers of cholesteric liquid crystal material capable of reflecting red, blue and green light.

The reflective nature of the cholesteric liquid crystal display device provides a degree of brightness in accordance with the ambient lighting. Therefore, a cholesteric liquid crystal display device provides a high brightness in bright conditions, particularly outdoors. In such conditions, the brightness is significantly better than conventional twisted nematic liquid crystal display devices whose brightness is generally limited by the power of a backlight and thus can be difficult to view in bright conditions.

Cholesteric liquid crystal display apparatuses have particular application to large displays for use as outdoors and in other large spaces. In order to provide a large display apparatus practical limitations on the manufacture of a single display device means it is necessary to combine a plurality of individual liquid crystal display devices in a two-dimensional array. This may be referred to as tiling of the display devices. Examples of a cholesteric liquid crystal display apparatus comprising a plurality of tiled display devices are shown for example in WO-01/88688 and WO-2004/051609.

For driving to display an image, the display device typically has an electrode arrangement of electrodes capable of providing driving of a plurality of pixels across the layer of cholesteric liquid crystal material on application of drive signals to the electrodes. The drive signals drive each pixel into a state selected in accordance with the image data. Various drive schemes are used to drive pixels into particular states having a range of reflectances to provide a range of grey levels.

Most development of cholesteric liquid crystal displays has concentrated on drive schemes using the stable states of the liquid crystal material, these being: the planar state providing a high reflectance; the focal conic state providing a low reflectance; and a range of mixture states in which the liquid crystal material has domains in each of the planar and focal conic states providing intermediate reflectances. The use of the stable states provides the advantage of low power consumption as energy is only needed to drive the change of state, whereafter the liquid crystal remains in a stable state displaying an image without consuming power. All current commercially available cholesteric liquid crystal display devices employ a drive scheme using the stable states.

Whilst use of the stable states provides a display device with a reasonable contrast ratio, the contrast ratio is limited by the fact that the focal conic state scatters light and this has a reflectance of the order of 3-4%. To improve the contrast ratio, it has been proposed to use the homeotropic state as the transparent state. For example, Nahm at al., “Amorphous Silicon Thin-Film Transistor Active-Matrix Reflective Cholesteric Liquid Crystal Display”, Asia Display 98, pp 979-982 (1998) discloses that use of the of the cholesteric liquid crystal material provides a higher contrast ratio because the homeotropic state has a lower reflectance than the focal conic state. It follows that the use of the homeotropic state as the dark state instead of the focal conic state has the advantages of increasing the contrast ratio and improving the colour gamut. However, Nahm et al. only discloses use of the planar or homeotropic state to provide dark and bright states with no intermediate grey levels.

A similar disclosure of use of the homeotropic state as a transparent state is present in Kawata et al., Materials and Devices Laboratories, Toshiba Corporation, “A High Reflective LCD with Double Cholesteric Liquid Crystal Layers”, SID 97, pp 246-249 (1997).

WO-2004/030335 also discloses driving of a cholesteric liquid crystal display device into the planar and homeotropic states to improve the contrast ratio. WO-2004/030335 additionally discloses that grey levels can be achieved by use of temporal modulation. In particular, in each video period a pixel is driven into the planar state and the homeotropic state for relative periods of time which are controlled in accordance with the image data. As a result of persistence of vision, a viewer perceives an average reflectance of the pixel over the video period. Thus, grey levels are achieved by varying the relative times spent in the planar and homeotropic states.

Unfortunately, the homeotropic state is not stable. As a result, to maintain a pixel in the homeotropic state requires continuous application of a drive signal. This increase the power consumption of the display apparatus as compared to use of the focal conic state as the transparent state. To deal with this problem, WO-2006/051273 discloses use a combined drive scheme in which the stable states are used to drive pixels into an upper range of reflectances, but the homeotropic state is used to drive pixels into a lower range of reflectances below the reflectance of the focal conic state.

In respect of drive schemes which use the stable states, there is a problem arising from the fact that response of the cholesteric liquid crystal material is temperature dependent. This means that the parameters of the drive signal (eg the voltage and/or period of the pulse(s)) required to achieve a state having a desired reflectance varies quite dramatically on the temperature of the liquid crystal material. This can be tackled by monitoring the temperature and using a look-up table to derive the appropriate parameters of the drive signal based on the measured temperature.

Although straightforward, this is quite costly to implement because of the memory requirement of the look-up tables, bearing in mind that in the case of a large display apparatus comprising multiple tiled display devices this needs to be implemented in the drive circuit of each display panel. Also a temperature sensor needs to be provided on each display device which is again costly. Alternatively, a single temperature sensor for the entire display apparatus may be used but this approach will not take account of temperature variations across the display apparatus which may be significant. Additionally, the display apparatus needs to be provided with equipment for controlling the temperature, such as heaters, heat-exchangers and fans, but such equipment is expensive. Furthermore it is very difficult to control the temperature of the display apparatus without placing the entire display apparatus in a box.

It would be desirable to reduce these problems arising from the temperature dependence of the response of the liquid crystal material.

### BRIEF SUMMARY OF THE INVENTION

According to one aspect of the present invention, there is provided a method of driving a cholesteric liquid crystal display apparatus in accordance with input image data having a number of possible grey levels, the display apparatus comprising at least one cholesteric liquid crystal display device which comprises at least one cell comprising a layer of cholesteric liquid crystal material and an arrangement of electrodes capable of driving of a plurality of pixels across the layer of cholesteric liquid crystal material on application of drive signals to the electrodes,

the method comprising:

dithering the input image data and quantizing the values of the pixels to respective ones of a predetermined number of quantized levels, the quantized levels corresponding to the reflectances of predetermined states into which the pixels may be driven, the predetermined number of quantized levels being less than the number of possible grey levels of the input image data; and

applying to the electrodes of the at least one cell drive signals which drive each respective pixel into the one of said predetermined states corresponding to the quantized value of the pixel in the error diffusion dithered image data.

According to another aspect of the present invention, there is provided a cholesteric liquid crystal display apparatus in which a similar method is implemented.

Thus the present invention involves the use of a reduced number of states of the cholesteric liquid crystal material. In particular the number of states, corresponding to the number of quantized levels, is less than the predetermined number of possible grey levels of the image data. Thus the intensity resolution of the image displayed on the display device is correspondingly reduced, but any consequent reduction in the quality of the image is limited or prevented by dithering of the image data.

Dithering is a technique for processing image data to create the illusion of colour depth in images with a limited colour palette. Dithering exploits the spatial integration which occurs as a physiological effect in the viewer's eye causing the viewer to perceive an average intensity over an area. This effect is exploited to limit any reduction in the quality of the image arising from the reduced intensity resolution. Thus dithering is applied in the present invention to allow use of a reduced number of states of the cholesteric liquid crystal.

Furthermore, the use of a reduced number of states has the benefit of greatly reducing the impact of the temperature dependence of the cholesteric liquid crystal material. This reduces the problems caused by the temperature dependence as discussed above.

The problems are reduced most by using only two states of the cholesteric liquid crystal material, for example the planar state and the homeotropic state, or else the planar state and the focal conic state. In this case it is possible to select a single drive signal in respect of each state that will drive the cholesteric liquid crystal material into the state in question across the entire working temperature range of operation of the display apparatus. For example to achieve the planar state, even though the minimum required voltage varies with temperature, it is possible to select a voltage which is greater than the minimum required voltage at all temperatures in the range of operation. Thus, with two states the measures described above to reduce the temperature dependence such as the use of temperature sensors and look-up tables and the use of equipment to control the temperature may be significantly reduced or removed altogether.

However a reduction in the impact of the temperature dependence can still be achieved by using a reduced number of states of the cholesteric liquid crystal material even if more than two states are used. This does imply the that the cholesteric liquid crystal material must be driven into a state of intermediate reflectance, for example a stable state having a reflectance intermediate the reflectance of the planar state and focal conic state. Thus the waveform of the drive signal is in this case temperature dependent. However, in comparison with use of a full range of intermediate states, as the number of states used is reduced the gap between the reflectances of the states is increased. This means that the impact of a change of temperature on the image perceived by the viewer is reduced. Thus, the need to vary the drive signal with temperature is correspondingly reduced. This reduces the burden of implementing the measures used to control the temperature as described above. For example it may be possible to omit the equipment used to control the temperature of the display apparatus and to use look-up tables with a much reduced temperature resolution, thereby significantly reducing the memory requirement and cost.

As well as reducing the impact of temperature dependence, the present invention may also reduce the constraints on the construction of the display device itself. For example, the thickness of the layer of liquid crystal material is not as critical and so the tolerances needed to manufacture the display device are improved. Similarly, it may be possible to use non-polished glass substrates for the cells in contrast to display devices using drive schemes employing stable states which typically need polished glass substrates.

Advantageously, the dithering is error diffusion dithering. This involves deriving the quantization error between the unquantized and quantized values of the pixel of the image data. This quantization error is diffused onto the values of the image data for pixels surrounding the respective pixel. Use of error diffusion dithering can provide a good improvement in the image quality although other forms of dithering may alternatively be used.

As mentioned above, the state used to provide the minimum reflectance may be the homeotropic state or the focal conic state. The use of the homeotropic state provides particular advantage. Firstly, the homeotropic state can be used to improve the contrast ratio of the display device for the reasons described above. Furthermore, the use of the homeotropic state means that the alignment of the cholesteric liquid crystal material may be provided simply to maximise the orientation of the planar state. This provides an improvement over the use of the focal conic state as the transparent state in which case the alignment must be a compromise between the planar and focal conic states. Furthermore, use of the homeotropic state improves the colour gamut as compared to use of the focal conic state.

However, the use of the focal conic state has the advantage of low power consumption and so is useful for applications where the power supply is limited.

To allow better understanding, an embodiment of the present invention will now be described by way of non-limitative example with reference to the accompanying drawings.

### BRIEF DESCRIPTION OF THE DRAWINGS

FIG. 1 is a front view of a display apparatus;

FIG. 2 is a cross-sectional view of the display apparatus;

FIG. 3 is a cross-sectional view of a cell of the display apparatus;

FIG. 4 is a front view of the electrode arrangement of the cells;

FIG. 5 is a diagram of the control circuit of the display apparatus;

FIG. 6 is a graph of a drive signal to drive a pixel into the planar state;

FIG. 7 is a graph of a drive signal to drive a pixel into the homeotropic state;

FIG. 8 is a graph of a drive signal to drive a pixel into the focal conic state;

FIG. 9 is a graph of the reflectance of the cholesteric liquid crystal material after application of a pulse of different voltages; and

FIG. 10 is a diagram illustrating the implementation of an error diffusion dithering algorithm.

### DETAILED DESCRIPTION OF THE INVENTION

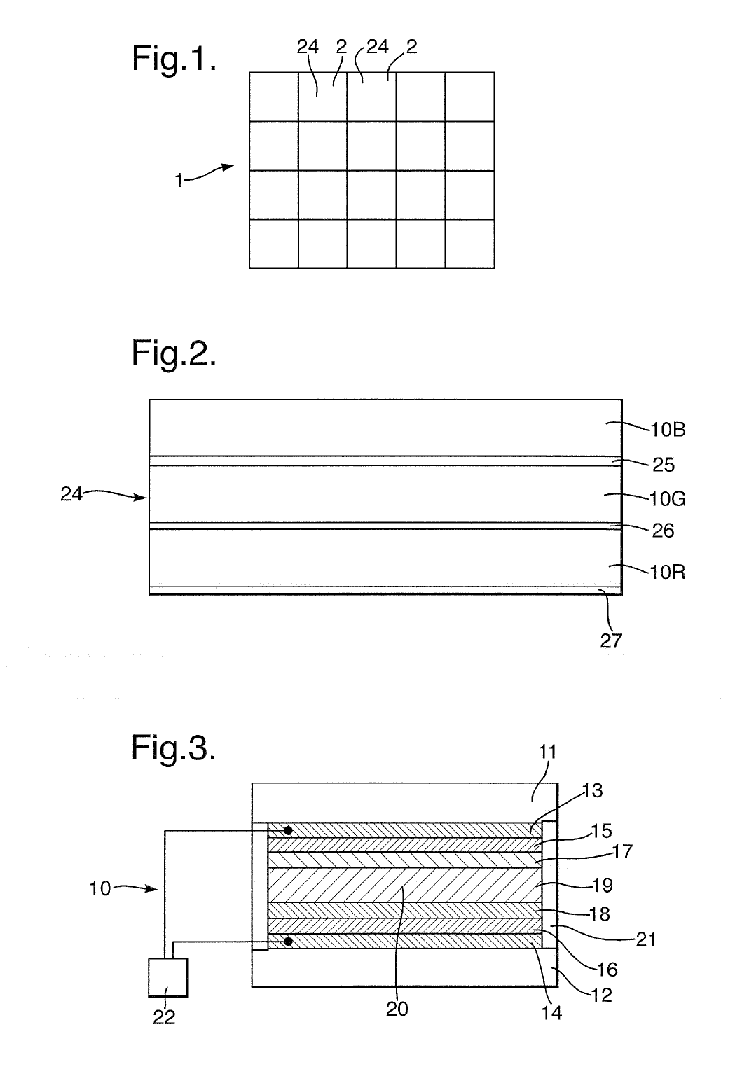

A cholesteric liquid crystal display apparatus 1 is shown in FIG. 1. The display apparatus 1 comprises a two-dimensional array of display panels 2. Each display panel 2 comprises a cholesteric liquid crystal display device 24 capable of displaying a reflective image on the front thereof. Although in this case each display panel 2 comprises a single display device 24, it is possible for a display panel 2 to comprise plural display devices 24 fixed together.

The display devices 24 are square or rectangular and tiled in a rectangular array to provide a common image plane. The display devices 24 may extend vertically, or each at a slight angle to the vertical which is advantageous in the case that the normal viewing angle is not horizontal for example in the common situation that the display apparatus 1 is disposed above the normal height of viewers. The display panels 2 may have any dimensions, for example a width of 36 cm and a height of 18 cm. The display devices 24 may abut one another around their edges to minimise the appearance of a boundary between the display panels 2. As an alternative, the display devices 24 may slightly overlap, e.g. if they are each at an angle to the vertical. In general the display panels 24 could have any shape providing a tiling or tessellation and any number of display panels 24 may be present.

There will first be described the structure of an individual display device 24, as shown in FIG. 2.

The display device 24 comprises three cells 10R, 10G, 10B each of which has the same construction as illustrated in FIG. 3 which shows a single cell 10.

The cell 10 has a layered construction, the thickness of the individual layers 11-19 being exaggerated in FIG. 3 for clarity.

The cell 10 comprises two rigid substrates 11 and 12, which may be made of glass or plastic. One option is that the substrates 11 and 12 may be made from non-polished glass. The substrates 11 and 12 have, on their inner facing surfaces, respective transparent conductive layers 13 and 14 formed as a layer of transparent conductive material, typically indium tin oxide. The conductive layers 13 and 14 are patterned to provide a rectangular array of addressable pixels, as described in more detail below.

Optionally, both conductive layers 13 and 14 are overcoated with a respective insulation layer 15 and 16, for example of silicon dioxide, or possibly plural insulation layers.

The substrates 11 and 12 define between them a cavity 20, typically having a thickness of 3 μm to 10 μm. The cavity 20 contains a liquid crystal layer 19 and is sealed by a glue seal 21 provided around the perimeter of the cavity 20. Thus the liquid crystal layer 19 is arranged between the conductive layers 13 and 14.

Each substrate 11 and 12 is further provided with a respective alignment layer 17 and 18 formed adjacent the liquid crystal layer 19, covering the respective conductive layer 13 and 14, or the insulation layer 15 and 16 if provided. The alignment layers 17 and 18 align and stabilise the liquid crystal layer 19 and are typically made of polyimide which may optionally be unidirectionally rubbed. Thus, the liquid crystal layer 19 is surface-stabilised, although it could alternatively be bulk-stabilised, for example using a polymer or a silica particle matrix.

The liquid crystal layer 19 comprises cholesteric liquid crystal material. Such material has several physical states in which the reflectivity and transmissivity vary. These states are the planar state, the focal conic state and the homeotropic (pseudo nematic) state, as described in I. Sage, Liquid Crystals Applications and Uses, Editor B Bahadur, Vol. 3, 1992, World Scientific, pp 301-343 which is incorporated herein by reference and the teachings of which may be applied to the present invention.

In the planar state, the liquid crystal layer 19 selectively reflects a bandwidth of light that is incident upon it. The reflectance spectrum of the liquid crystal layer 19 in the planar state typically has a central band of wavelengths in which the reflectance of light is substantially constant.

The wavelength λ of the reflected light are given by Bragg's law, ie λ=np, where n is the refractive index of the liquid crystal material seen by the light and P is the pitch length of the liquid crystal material. Thus in principle any colour can be reflected as a design choice by selection of the pitch length P. That being said, there are a number of further factors which determine the exact colour, as known to the skilled person. The planar state is used as the bright state of the display device 24.

Not all the incident light is reflected in the planar state. In a typical full colour display device 24 employing three cells 10, as described further below, the peak reflectivity is typically of the order of 40-45%. The light not reflected by the liquid crystal layer 19 is transmitted through the liquid crystal layer 19. The transmitted light is subsequently absorbed by a black layer 27 described in more detail below.

In the focal conic state, the liquid crystal layer 19 is, relative to the planar state, transmissive and transmits incident light. Strictly speaking, the liquid crystal layer 19 is mildly light scattering with a small reflectance, typically of the order of 3-4%. As light transmitted through the liquid crystal layer is absorbed by the black layer 27 described in more detail below, this state is perceived as darker than the planar state.

The focal conic and planar states are stable states which can coexist when no drive signal is applied to the liquid crystal layer 19. Furthermore the liquid crystal layer 19 can exist in stable states in which different domains of the liquid crystal material are each in a respective one of the focal conic state and the planar state. These are sometimes referred to as mixture states. In these mixture states, the liquid crystal material has a reflectance intermediate the reflectances of the focal conic and planar states. A range of such stable states is possible with different mixtures of the amount of liquid crystal in each of the focal conic and planar states so that the overall reflectance of the liquid crystal material varies, thus giving a range of grey levels.

The focal conic, planar and mixed states are stable states which persist after the drive signal is removed. Thus the drive signal need only be applied to drive the liquid crystal layer 19 into one of the stable states. Thus use of the stable states has a low power consumption.

In contrast the homeotropic state is not stable and so maintenance of the homeotropic state requires continued application of a drive signal. However, in the homeotropic state, the liquid crystal layer 19 is even more transmissive than in the focal conic state, typically having a reflectance of the order of 0.5-0.75%.

In general, either the focal conic state or the homeotropic state may be used as the dark state. The use of the focal conic state has the advantage of low power consumption but use of the homeotropic state has the advantage of providing a better contrast ratio and colour gamut as described further below.

As shown in FIG. 2, the display device 24 comprises the cells 10R, 10G and 10B arranged in a stack. Although three cells 10R, 10G and 10B are used in this example in general any number of cells may be used. The cells 10R, 10G and 10B have respective liquid crystal layers 19 which are arranged to reflect light with colours of red, green and blue, respectively. Thus the cells 10R, 10G and 10B will thus be referred to as the red cell 10R, the green cell 10G and the blue cell 10B. Selective use of the red cell 10R, the green cell 10G and the blue cell 10B allows the display of images in full colour, but in general a display device could be made with any number of cells 10, including one.

In FIG. 2, the front of the display device 24 from which side the viewer is positioned is uppermost and the rear of the display device 24 is lowermost. Thus, the order of the cells 10 from front to rear is the blue cell 10B, the green cell 10G and the red cell 10R. This order is preferred for the reasons disclosed in West and Bodnar, “Optimization of Stacks of Reflective Cholesteric Films for Full Color Displays”, Asia Display 1999 pp 20-32, although in principle any other order could be used.

The adjacent pair of cells 10R and 10G and the adjacent pair of cells 10G and 10B are each held together by respective adhesive layers 25 and 26.

There may be fixed to the front of the display device 24 a conventional UV protection sheet laminated onto the display device 24 or else a sheet or sheets of the type described in co-pending British Patent Application No. 0611895.4 which is incorporated herein by reference.

The display device 24 has a black layer 27 disposed to the rear, in particular by being formed on a rear surface of the red cell 10R which is rearmost. The black layer 27 may be formed as a layer of black paint. In use, the black layer 27 absorbs any incident light which is not reflected by the cells 10R, 10G or 10B. Thus when all the cells 10R, 10G or 10B are switched into a transmissive state, the display device appears black.

The display device 24 is similar to the type of device disclosed in WO-01/88688 which is incorporated herein by reference and the teachings of which may be applied to the present invention.

Each display device 24 has a respective drive circuit 22 which supplies a drive signal to the conductive layers 13 and 14 of each of the cells 10R, 10G and 10B which consequently apply the drive signal across the liquid crystal layer 19 to switch it between its different states. The drive circuit 22 may be mounted on the rear of the display device 24.

In each cell 10, the conductive layers 13 and 14 are patterned to provide an arrangement of electrodes which is capable of providing independent driving of a rectangular array of pixels across the liquid crystal layer 19 by different respective drive signals. In particular, the arrangement of electrodes is provided as follows.

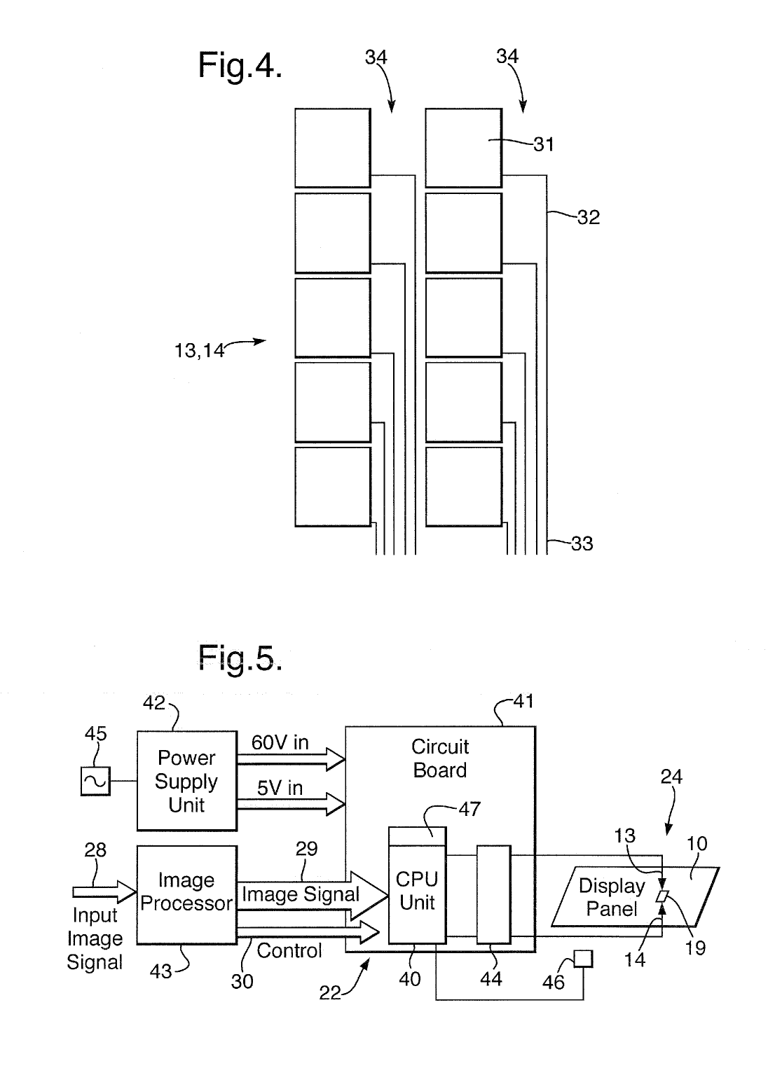

A first one of the conductive layers 13 or 14 (which may be either of the conductive layers 13 or 14) is patterned as shown in FIG. 4 and comprises a rectangular array of separate drive electrodes 31. The other, second one of the conductive layers 13 or 14 extends over the area opposite the entire array of drive electrodes 31 and thus acts as a common electrode. As an alternative, plural common electrodes may be provided, for example a separate common electrode extending over a column of drive electrodes 31. The use of plural common electrodes reduces the load on the drive circuit 22.

The first one of the conductive layers 13 or 14 further comprises separate tracks 32 each connected to one of the drive electrodes 31. Each track 32 extends from its respective drive electrode 31 to a position outside the array of drive electrodes 31 where the track forms a terminal 33. The drive circuit 22 makes an electrical connection to each of the terminals 33 and a common connection to the second one of the conductive layers 13 or 14. The connection may be made for example through a flexible connector extending between the control circuit 22 and the display device 24. Through this connection, the drive circuit 22 in use supplies a respective drive signal to each terminal 33 and thus the respective drive signals are supplied via the tracks 32 to the respective drive electrodes 31. In this manner, each drive electrode 31 independently receives its own drive signal and drives the area of the liquid crystal layer 19 adjacent to that drive electrode 31, which area of the liquid crystal layer 19 acts as a pixel. Therefore an array of pixels is formed in the liquid crystal layer 19 adjacent to the array of drive electrodes 31. As each drive electrode 31 receives a drive signal independently, each of the pixels is directly addressable.

Such direct addressing of each pixel is advantageous for a number of reasons. Direct addressing allows the pixels to be driven into the homeotropic state as a drive signal may be applied continuously to any selection of pixels. The electro-optic performance of the liquid crystal is improved as compared to passive multiplexed addressing because each pixel can be addressed independently without affecting or influencing the neighbouring pixels. Also, direct addressing allows compensation of non-uniformity in the parameters of the cell over the area of the display device, for example variation in thickness of the liquid crystal layer due to the manufacturing process, or temperature variation across the display device. Each pixel can be driven with a drive signal adapted, for example by varying parameters such as voltage or pulse time to compensate those variations.

However, such a direct addressing arrangement is not essential and other pixel arrangements are also possible. For example if only stable states of the liquid crystal are used, then a passive matrix electrode arrangement may be applied.

To accommodate the tracks 32 in the first one of the conductive layers 13 or 14, the drive electrodes 31 are arranged in lines (extending vertically in FIG. 4) with a gap 34 between each adjacent line of drive electrodes 31. The tracks 32 connected to a single line of drive electrodes 31 all extend along one of the gaps 34. All the tracks 32 from each drive electrode 31 in the line of drive electrodes 31 exit the array of drive electrodes 31 on the same side, that is lowermost in FIG. 4. As a result, all of the terminals 33 are formed on the same side of the display device 24. This has particular advantage when a plurality of identical display devices 24 are tiled to provide a larger image area because it reduces the gap needed between the individual display devices 24.

For clarity FIG. 4 illustrates the drive electrodes 31 and tracks 32 of only two lines of five pixels. The actual display device 24 may comprise any plural number of pixels in each dimension, typically 36 lines of 18 pixels or larger.

The electrical configuration of the drive circuit 22 will now be described with reference to FIG. 5. Only a single drive circuit 22 and display device 24 is shown in FIG. 5 for clarity. The drive circuit 22 is formed by a CPU unit 40 mounted on a circuit board 41 which is a printed circuit board. The CPU unit 40 has a memory 47.

Each circuit board 41 receives power from a single power supply unit 42 which receives power from an external supply 45, typically a mains supply or line supply. The power supply unit 42 generates a 3-5V supply which the circuit board 41 supplies to the CPU unit 40 and a 50-65V supply which is used in an amplifier block 44 to generate drive signals for the display device 24. As an alternative to the use of a power supply unit 42 external to the circuit board 41, each circuit board 41 may be arranged to receive power from a 24V supply by incorporating a low voltage regulator circuit to generate a 3-5V supply and a high voltage generator circuit to generate a 50-65V supply.

The CPU unit 40 of each circuit board 41 receives an image signal 29 representing an image from a single image processor 43, which is typically a conventional personal computer. In general, the image signal 29 may represent a static image or a video image. Typically the image signal 29 is digital LCD format running on LVDS bus. The image signal 29 is supplied from the image processor 43 to the circuit board 41 through a cable. The CPU unit 40 stores the image signal in the memory 47.

The image processor 43 derives the image signal 29 from an input image signal 28 as discussed further below. The image processor 43 also controls the selection of different images for display on the display device 24 from plural image signals 29 stored in the image processor 43. The image signal 29 consists of image data in respect of each pixel of the display device 24. The CPU unit 41 generates drive signals for each pixel in accordance with the image data of the image signal 29 supplied thereto.

In order to display an overall image on the display apparatus 1, each display device 24 displays a part of that image. This may be achieved by each display device 24 being provided with the complete image signal 29 and by the individual drive circuits 22 windowing a spatial portion of the image signal 29 to derive the drive signal from that spatial portion. This simplifies the cabling of the display devices 24 as they may be connected in a daisy-chain.

The cabling may also provide a control channel allowing a control signal 30 to be supplied to the display devices 24, for example from a personal computer. The control signal 30 may identify individual display devices 24 by respective IDs. The control signal 30 may also indicate to individual display devices 24 their location in the two-dimensional array, the display devices 24 selecting spatial portion of the image signal 29 to be windowed based on this. The control channel may be bi-directional and also used for monitoring, testing and software updating.

The drive signals generated by the CPU unit 41 are amplified by the amplifier block 44 on the circuit board 41 and are supplied to the conductive layers 13 and 14 to drive respective pixels in the liquid crystal layer 19 of the cells 10R, 10G and 10B.

There will now be described the form of the drive signals and processing of the image data performed by the drive circuit 22.

The drive circuit 22 selects a drive signal to apply to each pixel in accordance with the image data in respect of the pixel in the image signal 29 supplied to the CPU unit 41. The drive circuit 22 selects from a set of different drive signals which drive the pixel into a different state having a different reflectance. Only a limited number of predetermined states of the liquid crystal are used. The number of states used, and hence the number of grey levels of the image displayed on the display device 24, is less than the number of possible grey levels of the image data in the input image signal 28 supplied to the image processor 43. In other words the intensity resolution of the displayed image is reduced from that of the image data in the input image signal 28. As described further below, this reduces the impact of the temperature dependence of the cholesteric liquid crystal material of the liquid crystal layer 19. Typically the number of states used is eight or less, two states providing the maximum reduction in the impact of the temperature dependence.

The actual states into which the pixels are driven are as follows.

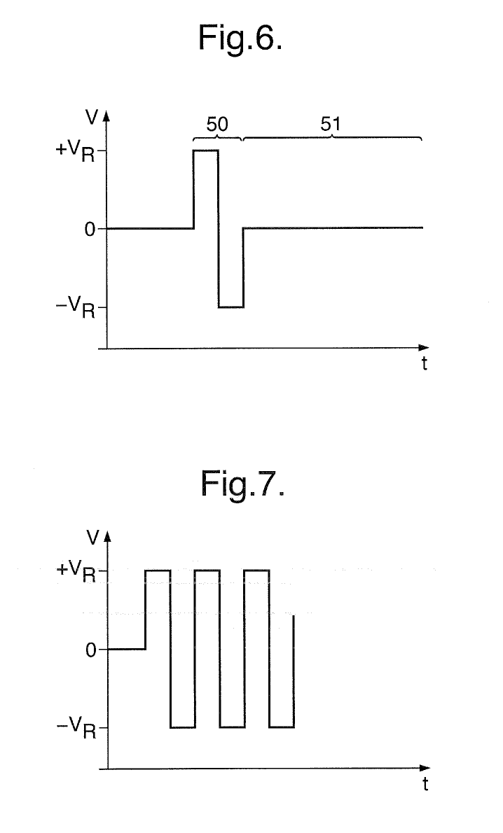

As the state of highest reflectance, the planar state is preferably used. The drive signal used to achieve this may be of a conventional form. The drive signal may takes the form shown in FIG. 6 which is a graph of voltage over time. In this case the drive signal comprises a reset pulse waveform 50, followed by a relaxation period. The reset pulse waveform 50 is shaped to drive the pixel into the homeotropic state. In this example, the reset pulse waveform 50 consists of a single balanced DC pulse which may equally be considered as two DC pulses 53 of opposite polarity. The relaxation period 51 causes the pixel to relax into the planar state. The reset pulse waveform releases quickly so that the relaxation is into the planar state, rather than the focal conic state. The planar state forms within a short time period typically 3 ms to 100 ms depending on liquid crystal materials and alignment layers used. Accordingly the relaxation period is longer than this.

The drive signal only needs to be applied once and thereafter the pixel remains in the planar state because it is stable.

The amplitude V_{R} and minimum period of the reset pulse waveform 50 needed to drive the pixel into the homeotropic state in general varies in dependence on a number of parameters such as the actual liquid crystal material used, the configuration of the cell 10, for example the thickness of the liquid crystal layer, pulse width and notably temperature. The amplitude V_{R} of the reset pulse waveform 50 is typically in the range from 40V to 70V but may be determined experimentally for a given display device 24 but importantly is selected to be sufficiently high to drive the pixel into the homeotropic state at all temperatures across the working temperature range of the display device 24 expected in use. Thus simply by making the amplitude V_{R} sufficiently high, the drive signal does not need to take the temperature into account. Conversely, the duration of the pulses 53 is kept sufficiently short to limit electrolysis of the liquid crystal layer 19 which can degrade its properties over time, for example being at most 300 ms, more preferably at most 200 ms, typically at most 150 ms. The duration of the pulses 53 is typically at least 10 ms, more preferably at least 50 ms.

As the state of lowest reflectance, the homeotropic state is preferably used. The drive signal used to achieve this may be of a conventional form. The drive signal may takes the form shown in FIG. 7 which is a graph of voltage over time. In this case the drive signal comprises a series of balanced DC pulses 58. The pulses 58 are applied continuously, because the homeotropic state is not stable. The pulses 58 have an amplitude V_{R} which is the same as the amplitude V_{R} of the reset pulse waveform 50 of the drive signal of FIG. 6 used to drive the pixel into the planar state. The comments above about the amplitude V_{R} and duration of the reset pulse waveform 50 apply equally to the pulses 58 of FIG. 7 used to drive the pixel into the homeotropic state with the effect that again temperature does not need to be taken into account.

Therefore in the case that only the planar and homeotropic (or planar) states are used, neither drive signal needs to take the temperature into account. This means that the drive circuit 22 need not include any special measure to take account of temperature, such as a temperature sensor and look-up tables, to vary the drive signal in accordance with temperature as would be necessary to drive a pixel into a wide range of stable states providing a full number of grey levels. This reduces the cost of the drive circuit 22 significantly as compared to the case that such measures are implemented. To quantify the reduction in the memory requirement of the drive circuit 22, one may compare with the case of a drive circuit which obtains 32 grey levels by driving the liquid crystal material into stable planar, focal conic and mixed states. In this case, typically twelve temperature steps are typically needed giving a memory requirement of 317 kbytes for the look up table. On top of this, to store the image data using 5 bits per pixel per colour, there is an additional memory requirement of 8 kbytes. In contrast, use of only two stable states requires no look-up table and only 2 bits per pixel per colour, giving memory requirement of 1 kbyte. This significantly reduced memory requirement provides an important cost saving for the drive circuit 22, particularly when considering the total number of display devices 24 in the display apparatus 1.

Another significant advantage of the use of only two states is that the amplifier block 44 does not need to include a variable amplifier which is expensive to implement.

However, optionally the drive circuit 22 may additionally use a number of states having intermediate reflectances. To achieve this the additional states will be stable mixed states comprising mixtures of liquid crystal material in each of the focal conic and planar states, as described above. For example the drive circuit 22 might use two mixed states to provide a total of four states allowing representation by two bits or might use six mixed states to provide a total of eight states allowing representation by three bits.

The drive signal used to achieve this may be of a conventional form. A wide range of forms of suitable drive signal are known and any may be applied.

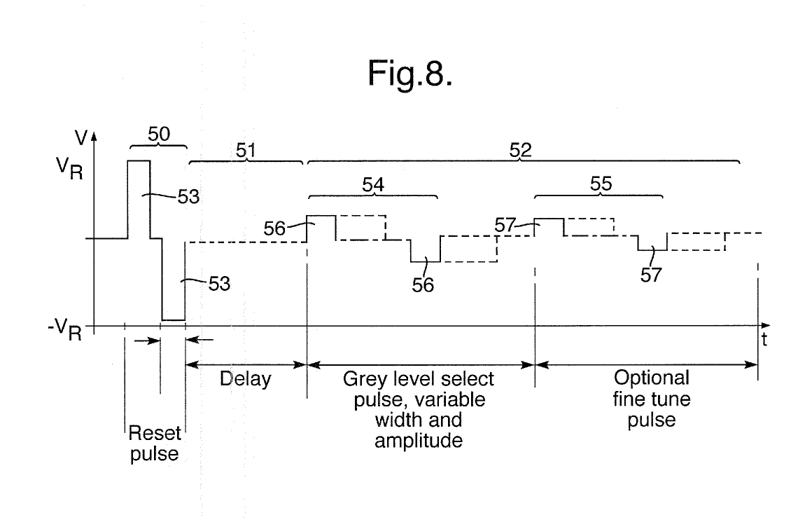

For example, the drive signal may takes the form shown in FIG. 8 which is a graph of voltage over time. In this case, the drive signal comprises a reset pulse waveform 50, followed by a relaxation period 51, followed by a selection pulse waveform 52. The reset pulse waveform 50 and relaxation period 51 have an identical form as in the drive signal of FIG. 6 used to drive the pixel into the planar state, as described above.

The selection pulse waveform 52 drives the pixel into a stable state having the desired reflectance and is varied in accordance with the value of the respective pixel in the image data. The selection pulse waveform 52 comprises an initial pulse 54 optionally followed by a tuning pulse 55. In this example, the initial pulse 54 and the tuning pulse 55 each consist of a single balanced DC pulse. Thus the initial pulse 54 may equally be considered as two DC pulses 56 of opposite polarity and the tuning pulse 55 may equally be considered as two DC pulses 57 of opposite polarity.

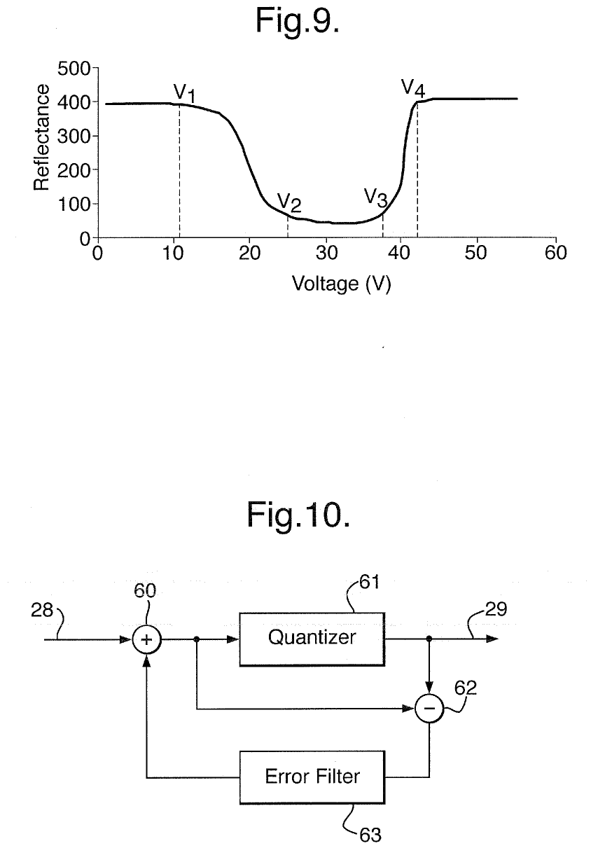

The amplitudes of the initial pulse 54 and the tuning pulse 55 are variable to drive the pixel into a stable state having a correspondingly variable reflectance. This may be understood by reference to FIG. 9 which shows the electro-optical curve of a typical liquid crystal material. In particular, FIG. 9 is a graph of the reflectance (in arbitrary units) of a liquid crystal initially in the planar state (that is at the end of the relaxation period 51) after application of a pulse of variable amplitude (that is the initial pulse 54), the reflectance being plotted against the amplitude of that pulse. Thus the amplitude of the initial pulse 54 is selected at a point on the curve of FIG. 8 between V1 and V2 or between V3 and V4 to provide the desired reflectance. The slope of the curve between V1 and V2 or between V3 and V4 allows states of different reflectances to be achieved.

The tuning pulse 55 may be omitted so that the selection pulse waveform 52 comprises a single pulse, that is the initial pulse 54. If the tuning pulse 55 is included, the initial pulse 54 drives the pixel into an initial stable state and the tuning pulse 55 drives the pixel into a final stable state. The tuning pulse 55 preferably has a lower amplitude than the initial pulse 54. The advantage of using the tuning pulse 55 is that it can improve the resolution by allowing the pixel to reach a number of different final stable states between the initial stable states. This improves the static image quality.

In some implementations there is always a tuning pulse 55 regardless of the desired reflectance. In other implementations, the tuning pulse 55 is either (1) absent if the desired reflectance is equal to the reflectance of one of the initial stable states or (2) present if the desired reflectance is equal to the reflectance of one of the final stable states.

As an alternative to the amplitude of the selection pulse waveform 52 being variable, the duration of the initial pulse 54 and/or the tuning pulse 55 may be variable, as shown by the dotted lines in FIG. 8, to achieve a variable reflectance. This provides the advantage that the amplifier block 44 does not need to include a variable amplifier but may instead employ pulse-width modulation. As another alternative the initial pulse 54 and the tuning pulse 55 may be replaced by a large number of short pulses.

The actual amplitudes and durations of the reset pulse waveform 50 and the selection pulse waveform 52 vary in dependence on a number of parameters such as the actual liquid crystal material used, the configuration of the cell 10, for example the thickness of the liquid crystal layer, and notably temperature. At a given temperature and as is routine in cholesteric liquid crystal display devices, these amplitudes and durations can be optimised experimentally for any particular display device 24. Typically, the reset pulse waveform 50 might have an amplitude of 50V to 60V and a duration of from 0.6 ms to 100 ms, more usually 50 ms to 100 ms. Typically the initial pulse 54 and/or the tuning pulse 55 might have an amplitude of from 10V to 30V and a duration of from 0.6 ms to 100 ms.

As to the temperature dependance, unfortunately the curve shown in FIG. 9 varies with temperature with the values of the points V1 to V4 shifting as the temperature changes. This means that the selection pulse waveform 52 needs to be correspondingly altered with temperature to bring the pixel into a state having a given reflectance. To account for this in the case that more than two states are used, a temperature sensor 46 may be used to monitor the temperature of the display panel 24, the drive circuit 22 varying the drive signal responsive to the output of the temperature sensor 46. This may be achieved by the CPU unit 40 using the output to look up the required voltages in a look-up table stored in the memory 47.

Whilst this does involve some additional measures to account for temperature variation, in fact the impact is significantly reduced as compared to the case that a full range of grey levels is provided by stable states. In that case the proximity of the reflectances of each state means that the drive signals must be controlled tightly with temperature. In practice this means that look-up tables must be employed with a fine temperature resolution. This has a high memory requirement for example requiring 12 temperature steps in the typical example given above. Furthermore some means for controlling the temperature of the display apparatus 1 may also be provided, for example heaters, heat-exchangers and/or air flow control.

In contrast when more than two states are used by the present drive circuit 22, the wide spacing of the reflectances of the states means that the quality of the image displayed on the display apparatus is much more tolerant to changes in temperature. In practice this means that the temperature resolution of the look-up tables is greatly reduced. Thus the look-up tables require significantly less memory which provides a significant cost saving. For example where four states are used it is expected that two temperature steps will be sufficient giving a memory requirement of 14 kbytes for the look-up table and 2 kbytes for storage of the image data. Similarly, where eight states are used it is expected that four temperature steps will be sufficient giving a memory requirement of 40 kbytes for the look-up table and 3 kbytes for storage of the image data. It will be appreciated that this represents a considerable saving as compared to the example given above for 32 grey levels in which there was a memory requirement of 317 kbytes for the look-up table and 8 kbytes for storage of the image data. Furthermore, it is not essential to provide means for controlling the temperature of the display apparatus 1.

In the above example, the pulses 50, 54 and 55 are all balanced DC pulses. In general any of these pulses 52, 54 and 55 may alternatively be DC pulses or AC pulses. In general it is preferred that the pulses are DC balanced to limit electrolysis of the liquid crystal layer 19 which can degrade its properties over time. Such DC balancing may be achieved by the use of balanced DC pulses, AC pulses or else DC pulses which are of alternating polarity for successive displayed images.

As an alternative to the homeotropic state, the focal conic state may be used as the state of lowest reflectance. The drive signal used to achieve this may be of a conventional form, for example as shown in FIG. 8 with the amplitude of the initial pulse 54 being selected between V2 and V3 in FIG. 9. Alternatively, the drive signal may take the form disclosed in WO-2005/122124, the contents of which are incorporated herein by reference. However, the advantage of using the homeotropic state is to improve the contrast ratio and the colour gamut. This is for basically the same reasons as are described in WO-2006/051273.

The above drive signals may be applied every time the image is changed. Even when the image is not changed, it may be desirable to apply the drive signals periodically to refresh the image. Conversely, when the image is changing frequently, the drive circuit 22 may store information about the previous image and only apply drive signals to pixels which change when the new image is displayed. This reduces power consumption but at the expense of possibly increasing the memory requirements of the drive circuit 22.

The limited number of states of the liquid crystal used in the display device 24 will now be discussed. First the input image signal 28 will be considered. High quality images may contain a large number of possible grey levels, for example of the order of 8 bits per pixel per colourg, equating to 24 bits per pixel in standard RGB image data and providing over 16 million colour shades. Various formats to reduce the amount of data are also used, for example the 5-5-6 scheme utilising 16 bits per pixel (6 green bits, 5 red bits and 5 blue bits) to provide 65,536 colour shades and colour indexing schemes that use various numbers of bits per pixel, for example 8 bits per pixel to provide 256 colour shades. To display such images on a cholesteric liquid crystal display device, typically there have been used drive schemes which provide a large number of grey levels, for example 32 grey levels for each colour cell.

In contrast, in the display apparatus 1, a much lower number of grey levels are used. The image processor 43 derives the image signal 29 with the reduced number of levels for by quantizing the input image signal 28. Thus the intensity resolution of the image displayed on the display device 24 is reduced as compared to the image data received from the image source 43. To reduce the impact on the visual quality of the image displayed on the display device 24, the image processor 43 derives the quantized image data of the image signal 29 by error diffusion dithering the image data of the input image signal 28.

The image data of the input image signal 28 is supplied through an adder 60 which as described further below adds a diffused quantization error to the image data of the input image signal 28 to generate error diffusion dithered image data. That error diffusion dithered image data output from the adder 60 is supplied to a quantizer 61 which quantizes the value of the pixel to one of a predetermined number of quantization levels. Each quantization level corresponds to one of the number of predetermined states used by the drive circuit 22. In particular, the value of each quantization level corresponds to the reflectance of the respective predetermined state of the liquid crystal material. For each pixel the quantizer 61 may simply select the quantization level which is closest to the value output from the adder 60. The quantized image data output from the quantizer 61 is supplied as the image signal 28 to the CPU unit 41.

Both the quantized image data output from the quantizer 61 and unquantized image data, that is the error diffusion dithered image data output from the adder 60, are supplied to a subtractor 62. The subtractor 62 derives the quantization error for each pixel between the quantized and unquantized image data. The quantization error is then passed through an error filter 63 which has the effect of diffusing the quantization error onto pixels surrounding the respective pixel from which the quantization error was generated. The output of the error filter 63 supplies the diffused quantization errors to the adder 60 at an appropriate timing to be added to the appropriate pixel. Thus the image data which is quantized in the quantizer 61 is actually the error diffusion dithered image data.

To implement the diffusion of the quantization error onto surrounding pixels, any of a wide variety of known error diffusion algorithms may be applied. One possibility is to use the Floyd-Steinberg algorithm which was the one of the earliest and still the most popular error diffusion algorithms. In this algorithm, the quantization error of a respective pixel is added to the surrounding pixels in proportions defined, in respect of scanning of the image from left to right and from top to bottom, by the error filter 63 employing the following error diffusion mask (x representing the position of the respective pixel and the numbers representing the proportions of the quantization error added to the surrounding pixels):

| | | |
|---|---|---|
| 0 | 0 | 0 |
| 0 | x | 7/16 |
| 3/16 | 5/16 | 1/16 |

However numerous other error diffusion algorithms are also known and can be applied here. One type of variation is to alter the error diffusion mask. Another type of variation is to carry out the scanning in different directions. For example if the image is scanned from right to left and from top to bottom, then the following error diffusion mask may be applied:

| | | |
|---|---|---|
| 0 | 0 | 0 |
| 7/16 | x | 0 |
| 1/16 | 5/16 | 3/16 |

and similarly the image could be scanned from top to bottom first with corresponding changes to the error diffusion mask.

Another type of variation is to generate two or more error diffusion dithered images by scanning of the image in different directions and to combine the two or more error diffusion dithered images. The combination may be performed mathematically in the image processor 43, or by the image processor alternately supplying the two or more error diffusion dithered images as the image signal 29 at a rate above the flicker fusion threshold so that a viewer perceives an average of the two or more error diffusion dithered images displayed on the display apparatus 24. This technique deals with the problem that the non-symmetrical nature of the error diffusion mask can with some images cause a perceptible pattern to be perceived in the image. However, combining images scanned in different directions can reduce this effect and so improve the perceived image quality.

The error diffusion dithering of the image data therefore spatially dithers the information which is lost by the quantization to a reduced number of levels as compared to the number of possible grey levels in the original image signal. The error diffusion dithering makes use of the spatial filtering which occurs in the eye as a physiological effect to reduce the loss of visual quality which would otherwise occur due to the reduced intensity resolution. Thus the error diffusion dithering compensates for the reduced number of states into which the cholesteric liquid crystal material of the liquid crystal layer 19 is driven. This effect is greatest when the pixel size is small compared to the viewing distance. For example in the case of a display apparatus 1 intended for use as a billboard for advertising, if the size of the pixels is 9 mm by 9 mm, then at viewing distances of around 40-50 m and above the image quality perceived by an average viewer is comparable to that achieved by employing a large number of grey levels without error diffusion dithering. At lower viewing distances, then the image can appear to contain noise but this effect can be reduced by using smaller pixels, or by using more states.

In the display apparatus 1, the error diffusion dithering is performed in the image processor 43 which is external to the drive circuits 22 attached to the display devices 24. In principle, the error diffusion dithering could alternatively be performed in the drive circuits 22. However performance of the error diffusion dithering in the image processor 43 has the advantage of limiting the processing power required in the drive circuits 22; avoiding problems in performing the dithering in respect of pixels at the edges of the display devices 24; and allowing the processing to be easily adapted to take account of global parameters such as external illumination and image type.

As an alternative to performing error diffusion dithering, the image processor 43 may perform some other form of dithering, such as ordered dithering, random dithering or average dithering. Error diffusion dithering provides the best improvement in perceived image quality, but the other dithering techniques are generally easier to implement within the image processor 43.

1. A method of driving a cholesteric liquid crystal display apparatus in accordance with input image data having a number of possible grey levels, the display apparatus comprising at least one cholesteric liquid crystal display device which comprises at least one cell comprising a layer of cholesteric liquid crystal material and an arrangement of electrodes capable of driving of a plurality of pixels across the layer of cholesteric liquid crystal material on application of drive signals to the electrodes,
the method comprising:
dithering the input image data and quantizing the values of the pixels to respective ones of a predetermined number of quantized levels, the quantized levels corresponding to the reflectances of predetermined states into which the pixels may be driven, the predetermined number of quantized levels being less than the number of possible grey levels of the input image data; and
applying to the electrodes of the at least one cell drive signals which drive each respective pixel into the one of said predetermined states corresponding to the quantized value of the pixel in the dithered image data.

2. A method according to claim 1, wherein said dithering is error diffusion dithering of the input image data performed by, for respective pixels:
quantizing the value of the pixel to one of a predetermined number of quantized levels;
deriving the quantization error between the unquantized and quantized values of the pixel of the image data; and
diffusing the quantization error onto the values of the image data for pixels surrounding the respective pixel.

3. A method according to claim 1, wherein said predetermined states include a planar state as the state having the highest reflectance.

4. A method according to claim 3, wherein said predetermined states include a homeotropic state as the state having the lowest reflectance.

5. A method according to claim 3, wherein said predetermined states include a focal conic state as the state having the lowest reflectance.

6. A method according to claim 3, wherein said predetermined states include one or more stable states having a reflectance intermediate the reflectance of the planar state and focal conic state of the cholesteric liquid crystal material.

7. A method according to claim 1, wherein said predetermined number of quantized levels is eight or less.

8. A method according to claim 1, wherein said predetermined number of quantized levels is equal to two.

9. A method according to claim 1, wherein the electrodes are formed in respective conductive layers on each side of the layer of liquid crystal material, at least one of the conductive layers being patterned to provide a plurality of separate drive electrodes each capable of providing independent driving an area of the layer of liquid crystal material adjacent the respective drive electrode as one of said pixels.

10. A method according to claim 9, wherein one of the conductive layers is patterned to provide said plurality of separate drive electrodes and the other of the conductive layer is shaped as at least one common electrode extending over a plurality of pixels.

11. A method according to claim 10, wherein said one of the conductive layers which is patterned to provide a plurality of separate drive electrodes further comprises a separate track connected to each of the separate drive electrodes and extending to a position outside the array of addressable pixels where the tracks form terminals which are electrically connected to the drive circuit.

12. A method according to claim 9, wherein the at least one cell comprises two substrates defining therebetween a cavity in which said a layer of liquid crystal material is disposed, the respective conductive layers each being formed on one of the substrates.

13. A cholesteric liquid crystal display apparatus for displaying an image in accordance with input image data having a number of possible grey levels, the apparatus comprising:
at least one cholesteric liquid crystal display device which comprises at least one cell comprising a layer of cholesteric liquid crystal material and an arrangement of electrodes capable of driving of a plurality of pixels across the layer of cholesteric liquid crystal material on application of drive signals to the electrodes;
an image processor arranged to dither the input image data and quantize the values of the pixels to respective ones of a predetermined number of quantized levels, the quantized levels corresponding to the reflectances of predetermined states into which the pixels may be driven, the predetermined number of quantized levels being less than the number of possible grey levels of the input image data; and
a drive circuit supplied with the error diffusion dithered image data and arranged to apply drive signals which drive each respective pixel into the one of said predetermined states corresponding to the quantized value of the pixel in the dithered image data.

14. A cholesteric liquid crystal display apparatus according to claim 13, wherein said image processor is arranged to error diffusion dither the input image data performed by, for respective pixels:
quantizing the value of the pixel to one of a predetermined number of quantized levels;
deriving the quantization error between the unquantized and quantized values of the pixel of the image data; and
diffusing the quantization error onto the values of the image data for pixels surrounding the respective pixel.

15. A cholesteric liquid crystal display apparatus according to claim 13, wherein said predetermined states include a planar state as the state having the highest reflectance.

16. A cholesteric liquid crystal display apparatus according to claim 15, wherein said predetermined states include a homeotropic state as the state having the lowest reflectance.

17. A cholesteric liquid crystal display apparatus according to claim 15, wherein said predetermined states include a focal conic state as the state having the lowest reflectance.

18. A cholesteric liquid crystal display apparatus according to claim 15, wherein said predetermined states include one or more stable states having a reflectance intermediate the reflectance of the planar state and focal conic state of the cholesteric liquid crystal material.

19. A cholesteric liquid crystal display apparatus according to claim 13, wherein said predetermined number of quantized levels is eight or less.

20. A cholesteric liquid crystal display apparatus according to claim 13, wherein said predetermined number of quantized levels is equal to two.

21. A cholesteric liquid crystal display apparatus according to claim 13, wherein the electrodes are formed in respective conductive layers on each side of the layer of liquid crystal material, at least one of the conductive layers being patterned to provide a plurality of separate drive electrodes each capable of providing independent driving an area of the layer of liquid crystal material adjacent the respective drive electrode as one of said pixels.

22. A cholesteric liquid crystal display apparatus according to claim 21, wherein one of the conductive layers is patterned to provide said plurality of separate drive electrodes and the other of the conductive layer is shaped as at least one common electrode extending over a plurality of pixels.

23. A cholesteric liquid crystal display apparatus according to claim 22, wherein said one of the conductive layers which is patterned to provide a plurality of separate drive electrodes further comprises a separate track connected to each of the separate drive electrodes and extending to a position outside the array of addressable pixels where the tracks form terminals which are electrically connected to the drive circuit.

24. A cholesteric liquid crystal display apparatus according to claim 21, wherein the at least one cell comprises two substrates defining therebetween a cavity in which said a layer of liquid crystal material is disposed, the respective conductive layers each being formed on one of the substrates.
